(19) United States
(12) Patent Application Publication
(10) Pub. No.: US 2003/0098079 A1
(43) Pub. Date: May 29, 2003

(54) FLOW TRANSDUCER MANIFOLD WITH RUBBER/POLYMER CONSTRUCTION

(76) Inventors: Adrian D. de Silva, Riverside, CA (US); Samuel A. Glukhov, Sherman Oaks, CA (US)

Correspondence Address: STETINA BRUNDA GARRED & BRUCKER, 75 ENTERPRISE, SUITE 250, ALISO VIEJO, CA, 92656, US

(21) Appl. No.: 09/997,430

(22) Filed: Nov. 29, 2001

(51) Int. Cl. F16K 1/00

(52) U.S. Cl. 137/884

(57) ABSTRACT

A manifold assembly comprising a manifold block. The manifold block is preferably fabricated from an elastomeric material, such as a polymer material or a rubber material. The manifold block defines a generally planar top surface and a bottom surface. Formed within the manifold block are a plurality of flow apertures which extend between the top and bottom surfaces, and from the top surface to an interior location of the manifold block. Also formed within the too surface of the manifold block are a plurality of flow channels. The flow channels are arranged in a pattern wherein each of at least some of the flow channels place at least two of the flow apertures into fluid communication with each other. Cooperatively engaged to the manifold block is at least one solenoid which is operative to facilitate the selective placement of at least two of the flow apertures into fluid communication with each other. Also attached to the manifold block is a sealing plate which covers each of the flow channels disposed within the top surface.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present invention relates generally to respiratory fluid flow regulation and monitoring equipment, and more particularly to a uniquely configured manifold which is fabricated from a rubber or polymer material and is operative to reliably and rapidly connect multiple pneumatic lines to achieve a desired flow path.

As is known in the medical arts, there are various respiratory or ventilation apparatuses which are adapted for use with patients having respiratory problems and/or for monitoring and diagnostic/testing purposes. Many of these medical apparatuses require the use of multiple pneumatic lines which extend between a device operatively positioned upon or within the patient's body and an external instrument such as a ventilation, monitoring, or measurement instrument. The proper functionality of the overall apparatus including the instrument and the patient device typically requires that pneumatic flow through the apparatus be channeled along prescribed flow paths in a particular pattern. To achieve this result, a currently employed practice is to simply complete a cumbersome, time consuming tubing interconnection process employing the use of multiple connectors of simplified construction. To avoid the need to use these multiple connectors, there has been developed in the prior art manifolds to which the various pneumatic lines may be attached to achieve the desired flow pattern. In certain applications, monitoring devices such as pressure transducers or flow transducers are interfaced directly to the manifold for providing a particular measurement communicated via an electrical line to the monitoring or measurement apparatus.

These manifolds, as known in the medical arts, are often fabricated in a conventional manner, i.e., the machining of a block fabricated from a metal material such as aluminum. This machining process, however, is extremely costly, with such costs often being escalated by the need to plug various pilot holes which are formed within the block to facilitate the creation of the necessary internal flow passages. As an alternative to machining a block of metal material, it is also known in the prior art to form these manifolds through the use of laminated plastic layers which are glued to each other in a stacked arrangement. However, this fabrication technique for the manifold is also not cost effective due to the necessity of having to machine each of the sheets in a manner facilitating the formation of the necessary internal flow passages when the sheets are glued to each other in the stacked arrangement.

The present invention addresses the deficiencies of prior art medical apparatus manifolds by providing a manifold which is fabricated from a polymer or rubber material. The fabrication of the present manifold from an elastomeric material allows the couplings or ports of ancillary devices (e.g., pressure transducers) to be maintained in sealed engagement to the manifold simply by advancing the couplings or ports of such ancillary devices into complementary openings or apertures within the manifold. The various orifices/through holes and flow channels of the present manifold are molded thereinto, thus eliminating the need for any machining process. The manner in which the present manifold is formed also allows for the interconnection of the various through holes and flow channels without the need to complete a plugging process involved in the manufacture of manifolds from metal blocks. These, and other features and advantages attendant to the present invention, will be discussed in more detail below.

### BRIEF SUMMARY OF THE INVENTION

In accordance with the present invention, there is provided a manifold assembly which comprises a manifold block. The manifold block defines a generally planar top surface, an opposed bottom surface, and at least one side surface which extends between the top and bottom surfaces. Formed within the manifold block are a plurality of flow apertures which extend between the top and bottom surfaces, and from the top surface to an interior location of the manifold block. Additionally, formed within the top surface of the manifold block are a plurality of flow channels. The flow channels are arranged in a pattern wherein each of at least some of the flow channels place at least two of the flow apertures into fluid communication with each other. In one embodiment of the present invention, one of the flow channels may be used to facilitate the fluid communication of one of the flow apertures with ambient air, i.e., to serve as a vent. Each of the flow channels defines a peripheral edge, with the manifold block preferably including a plurality of ribs formed on and extending perpendicularly from the top surface thereof. Each of the ribs extends along the peripheral edge of a respective one of the flow channels. Attached to the manifold block is a sealing plate which effectively covers and seals each of the flow channels disposed within the top surface.

The manifold assembly of the present invention further preferably comprises at least one solenoid which is cooperatively engaged to the manifold block in a manner facilitating the selective placement of at least two of the flow apertures into fluid communication with each other. More particularly, the solenoid is partially advanced into a complementary bore which is formed within the side surface of the manifold block. The diameter of the body of that portion of the solenoid advanced into the bore preferably exceeds the diameter of the bore, thus maintaining the solenoid in sealed engagement to the manifold block. The manifold assembly further includes a pressure transducer which is itself cooperatively engaged to the manifold block in a manner communicating with at least two of the flow apertures formed therein. The pressure transducer includes a pair of ports which are advanced into respective ones of the flow apertures, The diameters of the pressure ports exceed the diameters of those flow apertures into which they are advanced, thus similarly maintaining the pressure transducer in sealed engagement to the manifold block. The manifold block is preferably fabricated from an elastomeric material, such as a polymer material or a rubber material.

### BRIEF DESCRIPTION OF THE DRAWINGS

These, as well as other features of the present invention, will become more apparent upon reference to the drawings wherein:

FIG. 1 is a top perspective view of a manifold assembly constructed in accordance with a first embodiment of the present invention;

FIG. 2 is a bottom perspective view of the manifold assembly shown in FIG. 1, illustrating various components of the manifold assembly as being exploded from the manifold block thereof;

FIG. 3 is a top plan view of the manifold block of the manifold assembly of the first embodiment;

FIG. 4 is a bottom plan view of the manifold block shown in FIG. 3;

FIG. 5 is a schematic depicting various flow apertures and flow channels in the manifold assembly of the first embodiment;

FIG. 6 is a top plan view of a manifold assembly constructed in accordance with a second embodiment of the present invention; and

FIG. 7 is a bottom plan view of the manifold assembly shown in FIG. 6.

### DETAILED DESCRIPTION OF THE INVENTION

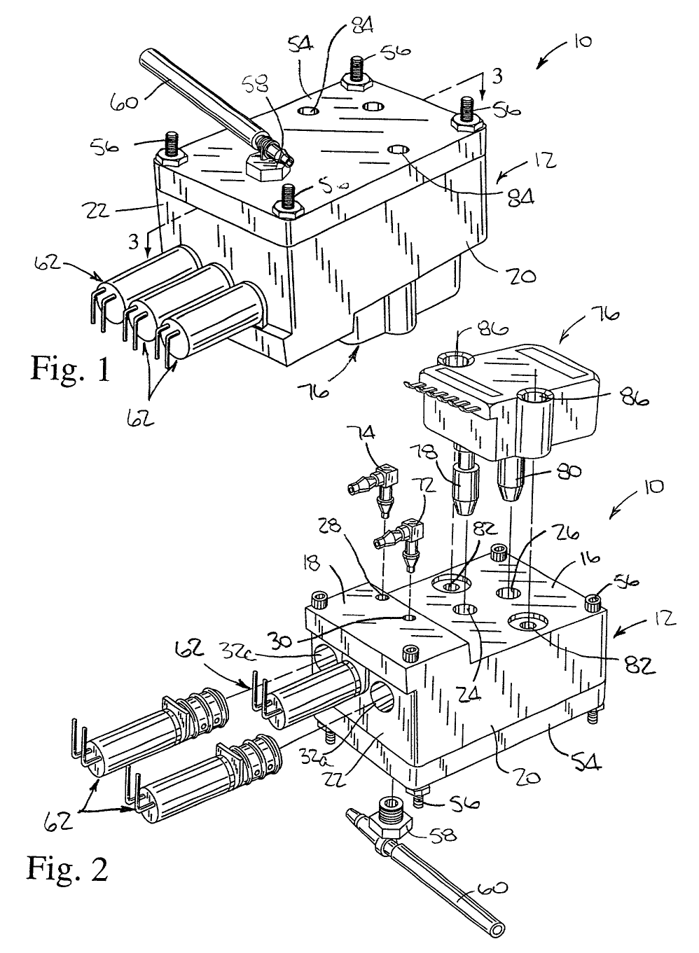

Referring now to the drawings wherein the showings are for purposes of illustrating preferred embodiments of the present invention only, and not for purposes of limiting the same, FIGS. 1 and 2 perspectively illustrate a manifold assembly 10 constructed in accordance with a first embodiment of the present invention. The manifold assembly 10 comprises a manifold block 12 which is fabricated from an elastomeric material such as a polymer material or a rubber material. The selection of an elastomeric material for the manifold block 12 is for purposes which will be discussed in more detail below. The manifold block 12 has a generally rectangular configuration, and defines a generally planar top surface 14. The manifold block 12 further defines a generally planar first bottom surface section 16 and a generally planar second bottom surface section 18 which is perpendicularly elevated relative to the first bottom surface section 16. The first and second bottom surface sections 16, 18 each extend in generally parallel relation to the top surface 14. The manifold block 12 further defines a side surface which includes an opposed pair of longitudinal side surface sections 20 and an opposed pair of lateral side surface sections 22.

Referring now to FIGS. 1-4, disposed within the approximate center of the top surface 14 of the manifold block 12 is a first flow aperture 24. The first flow aperture 24 extends through the manifold block 12 from the top surface 14 to the first bottom surface section 16 thereof. The first flow aperture 24 is not of uniform diameter, with that portion thereof extending to the first bottom surface section 16 having an increased diameter as compared to the remainder thereof extending to the top surface 14. Also formed within and extending through the manifold block 12 from the top surface 14 to the first bottom surface section 16 thereof is a second flow aperture 26. The second flow aperture 26 is identically configured to the first flow aperture 24, with a portion thereof extending to the first bottom surface section 16 having a diameter exceeding that of the remainder thereof which extends to the top surface 14.

Also included in the manifold block 12 is a third flow aperture 28 which itself extends through the manifold block 12 from the top surface 14 to the second bottom surface section 18 thereof. Disposed in close proximity to the third flow aperture 28 is a fourth flow aperture 30 which also extends through the manifold block 12 from the top surface 14 to the second bottom surface section 18 thereof.

Formed within the lateral side surface section 22 disposed adjacent the second bottom surface section 18 are three bores 32a, 32b, 32c which are linearly aligned with each other. Each of the bores 32a, 32b, 32c is cylindrically configured, i.e., has a generally circular cross-sectional configuration. The bores 32a, 32b, 32c preferably extend to a common depth. In this regard, the depth of the bores 32a, 32b is such that they do not intersect respective ones of the third and fourth flow apertures 28, 30.

Also formed within the manifold block 12 is a fifth flow aperture 34 which extends from the top surface 14 to the bore 32c (i.e., the fifth flow aperture 34 fluidly communicates with the bore 32c). Similarly, a sixth flow aperture 36 is formed within the manifold block 12 and extends from the top surface 14 into fluid communication with the bore 32c. A seventh flow aperture 38 formed within the manifold block 12 extends from the top surface 14 into fluid communication with the bore 32a, with an eighth flow aperture 40 formed within the manifold block 12 extending from the top surface 14 into fluid communication with the bore 32b. The third flow aperture 28 itself fluidly communicates with the bore 32a via internal flows passages of the manifold block 12 extending therebetween. Similarly, the fourth flow aperture 30 fluidly communicates with the bore 32b via internal flow passages of the manifold block 12 extending therebetween. Also formed within the manifold block 12 is a ninth flow aperture 42. The ninth flow aperture 42 is not of uniform diameter. In this regard, the ninth flow aperture 42 includes an enlarged region 42a which is internal to the manifold block 12 and defines a fluid reservoir used for purposes which will be discussed in more detail below. The enlarged region 42a of the ninth flow aperture 42 itself fluidly communicates with the bore 32c via internal flow passages of the manifold block 12 extending therebetween. That portion of the ninth flow aperture 42 extending to the top surface 14 of the manifold block 12 is of a reduced diameter as compared to the enlarged region 42a.

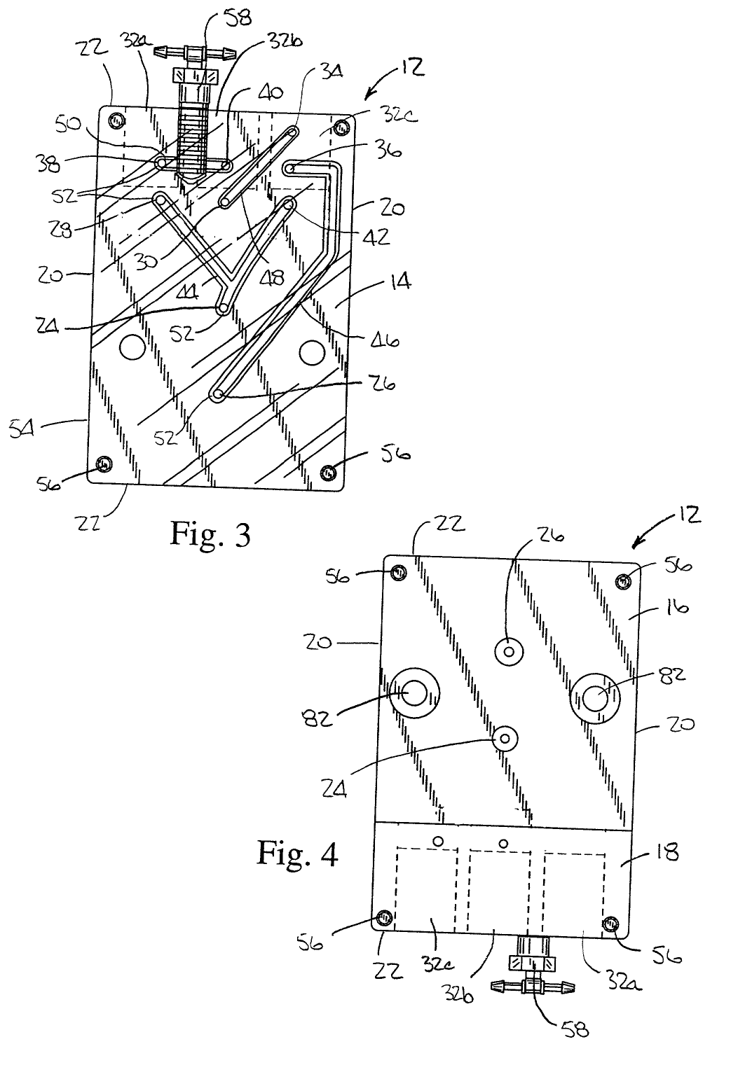

Formed within the top surface 14 of the manifold block 12 is a first flow channel 44 which has a generally Y-shaped configuration and places the first flow aperture 24 into fluid communication with both the third flow aperture 28 and the ninth flow aperture 42. Also formed in the top surface 14 is a second flow channel 46 which places the second flow aperture 26 into fluid communication with the sixth flow aperture 36. A third flow channel 48 and a fourth flow channel 50 are also formed in the top surface 14, with the third flow channel 48 placing the fourth flow aperture 30 into fluid communication with the fifth flow aperture 34. The fourth flow channel 50 places the seventh flow aperture 38 into fluid communication with the eighth flow aperture 40. As best seen in FIG. 3, the first, second, third and fourth flow channels 44, 46, 48, 50 each include a rib 52 which is formed on the top surface 14 of the manifold block 12 and extends about the periphery thereof. Each rib 52 is sized to protrude perpendicularly a small distance from the top surface 14. In the manifold block 12, the first through ninth flow apertures, the first through fourth flow channels, the bores and the various internal flow passages described above are all molded into the manifold block 12. Thus, no machining operations for the manifold block 12 are required, thereby substantially decreasing the associated fabrication costs. The elimination of the machining step to form the manifold block 12 in turn eliminates the necessity of having to plug any pilot holes which would otherwise be required to facilitate the formation of the various internal flow passages within the manifold block 12.

The manifold assembly 10 further comprises a generally rectangular sealing plate 54 which is attached to the manifold block 12 in a manner covering the top surface 14 thereof. The sealing plate 54, like the top surface 14, has a generally rectangular configuration. The attachment of the sealing plate 54 to the manifold block 12 is preferably facilitated by four fasteners 56 which are advanced through the manifold block 12 and through respective ones of the four corner regions defined by the sealing plate 54. The sealing plate 54 is preferably sized relative to the manifold block 12 such that the longitudinal sides of the sealing plate 54 are substantially flush with respective ones of the longitudinal side surface sections 20, and the lateral side surfaces of the sealing plate 54 are substantially flush with respective ones of the lateral side surface sections 22. The sealing plate 54 is preferably fabricated from a transparent or translucent plastic material. When attached to the manifold block 12 via the fasteners 56, the sealing plate 54 effectively seals or encloses each of the first through fourth flow channels 46, 48, 50, 52. The sealing of these flow channels is assisted by the compression of the rib 52 which occurs when the sealing plate 54 is attached to the manifold block 12. Thus, the ribs 52 serve a sealing function which assures that any fluids are incapable of escaping from any of the first through fourth flow channels 44, 46, 48, 50 between the top surface 14 of the manifold block 12 and the sealing plate 54.

Attached to the sealing plate 54 in the manifold assembly 10 is a high pressure inlet port or coupling 58. The coupling 58 is attached to the sealing plate 54 at a location whereat it fluidly communicates with the fourth flow channel 50. As seen in FIG. 1, the coupling 58 may be threadably received into a complementary, internally threaded bore which extends between the top and bottom surfaces of the sealing plate 54 in alignment with the fourth flow channel 50. Alternatively, the coupling 58 may be threadably advanced into an internally threaded bore extending into one of the lateral surfaces of the sealing plate 54 into communication with the fourth flow channel 50 in the manner shown in FIG. 3. Fluidly connected to the coupling 58 is a high pressure inlet line 60 which does not constitute a portion of the manifold assembly 10.

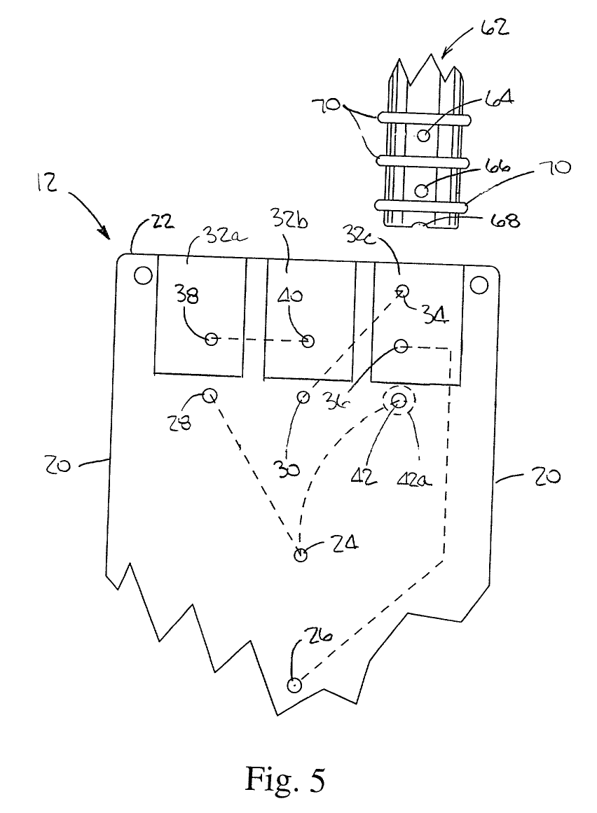

The manifold assembly 10 further comprises three identically configured solenoids 62, portions of which are advanced into respective ones of the bores 32a, 32b, 32c. As best seen in FIG. 5, each solenoid 62 includes a normally closed port 64, a normally open port 66, and a common port 68. Disposed upon and extending about the body of each solenoid 62 are three O-rings 70. One O-ring 70 extends between the ports 64, 66, with another O-ring 70 extending between the ports 66, 68. The third O-ring 70 extends between the port 64 and the remainder of the body of the solenoid 62. The solenoids 62 are electrically connectable to a control unit via leads protruding from those ends thereof opposite the ends including the ports 68. In the manifold assembly 10, the bores 32a, 32b, 32c are preferably sized so as to have a diameter slightly less than that of the diameters of the O-rings 70 of the solenoids 62. Thus, the advancement of each solenoid 62 into a respective one of the bores 32a, 32b, 32c will result in a slight radial expansion of the bores 32a, 32b, 32c which is made possible by the resiliency of the polymer or rubber material preferably used to fabricate the manifold block 12. Due to such resiliency and the resultant firm engagement between the manifold block 12 and O-rings 70 of the solenoids 62, the ports 64, 66, 68 of each solenoid 62 are fluidly isolated or sealed from each other within a respective one of the bores 32a, 32b, 32c. The O-ring 70 disposed furthest from the port 68 seals the port 64 from ambient air. As will be recognized, the internal flow passages formed within the manifold block 12 to fluidly connect the third and seventh flow apertures 28, 38 to the bore 32a, the fourth and eighth flow apertures 30, 40 to the bore 32b, and the fifth, sixth and ninth flow apertures 34, 36, 42 to the bore 32c will be configured to achieve such fluid communication with respective ones of the ports 64, 66, 68 of the corresponding solenoid 62 in a manner designed to achieve a flow pattern which will be described in more detail below.

As best seen in FIG. 2, the manifold assembly 10 further comprises a high pressure coupling 72 which is advanced into that portion of the fourth flow aperture 30 extending to the second bottom surface section 18. A low pressure coupling 74 of the manifold assembly 10 is advanced into that portion of the third flow aperture 28 extending to the second bottom surface section 18 of the manifold block 12. The couplings 72, 74 include regions which are of an increased diameter relative to the diameters of those portions of the third and fourth flow apertures 28, 30 extending to the second bottom surface section 18. Thus, a similar sealing effect to that described in relation to the advancement of the solenoids 62 into the bores 32a, 32b, 32c is achieved attributable to the radial expansion of the third and fourth flow apertures 28, 30 made possible by the fabrication of the manifold block 12 from an elastomeric material.

The manifold assembly 10 further comprises a pressure transducer 76 which is operatively coupled to the manifold block 12. The pressure transducer 76 includes a low pressure port 78 and a high pressure port 80 which extend from a common side thereof. The low pressure port 78 is advanceable into the first flow aperture 24, with the high pressure port 80 being advanceable into the second flow aperture 26. The diameters of portions of the low and high pressure ports 78, 80 exceed the diameters of those portions of the first and second flow apertures 24, 26 which extend to the first bottom surface section 16 of the manifold block 12. Thus, the advancement of the ports 78, 80 into respective ones of the first and second flow apertures 24, 26 facilitates the radial expansion thereof due to the fabrication of the manifold block 12 from the elastomeric material, with the resiliency of such material thereby effectuating sealed contact or engagement between the manifold block 12 and the ports 78, 80 of the pressure transducer 76.

Though not shown, the pressure transducer includes an internal chamber having a diaphragm disposed therein. The diaphragm segregates the chamber into a low pressure section which fluidly communicates with the low pressure port 78 and a high pressure section which fluidly communicates with the high pressure port 80. The volumes of the low and high pressure sections within the pressure transducer 76 are not equal, the significance of which will be discussed in more detail below in relation to the enlarged region 42a of the ninth flow aperture 42. To maintain the pressure transducer 76 in firm attachment to the manifold block 12, a pair of apertures 82 are preferably formed within the manifold block 12, with the apertures 82 being coaxially aligned with a corresponding pair of apertures 84 formed within the sealing plate 54. When the ports 78, 80 are advanced into respective ones of the first and second flow apertures 24, 26, a pair of apertures 86 defined by the pressure transducer 76 are coaxially aligned with respective pairs of the apertures 82, 84. The advancement of a fastener (not shown) into each coaxially aligned set of apertures 82, 84, 86 facilitates the attachment of the pressure transducer 76 to the manifold block 12.

Having thus described the major structural attributes of the manifold assembly 10, an exemplary method of using the same will now be discussed with particular reference to FIG. 5. More particularly, it is contemplated that the manifold assembly 10 may be used in conjunction with an active or passive pneumatic element such as a flow transducer. In the following example, the manifold assembly is used in conjunction with a flow transducer. In this application, the high pressure coupling 72 will be fluidly connected to the upstream side of the flow transducer, with the low pressure coupling 74 being fluidly connected to the downstream side of the flow transducer. In one operational mode of the manifold assembly 10, high pressure fluid (e.g. gas, air) enters the high pressure coupling 72 from the upstream side of the flow transducer, and hence enters the fourth flow aperture 30. The high pressure fluid flows through the third flow channel 48 into the fifth flow aperture 34 which, as indicated above, communicates with the bore 32c. The solenoid 62 disposed within the bore 32c is actuated such that the high pressure fluid entering the fifth flow aperture 34 via the third flow channel 48 is communicated to the sixth flow aperture 36. The high pressure fluid in turn flows from the sixth flow aperture 36 to the second flow aperture 26 via the second flow channel 46. From the second flow aperture 26, the high pressure fluid flows into the high pressure section of the pressure transducer 76 via the high pressure port 80 which, as indicated above, is advanced into the second flow aperture 26.

Low pressure fluid from the downstream side of the flow transducer flows into the low pressure coupling 74, and hence the third flow aperture 28 which fluidly communicates therewith. From the third flow aperture 28, the low pressure fluid flows to the first flow aperture 24 via a portion of the first flow channel 44. The low pressure fluid flows from the first flow aperture 24 into the low pressure section of the pressure transducer via the low pressure port 78 which, as also indicated above, is advanced into the first flow aperture 24. In addition to flowing into the low pressure port 78, the low pressure fluid flows into the ninth flow aperture 42 via another portion of the first flow channel 44. When entering the ninth flow aperture 42, the low pressure fluid flows into the enlarged region 42a thereof. The solenoid 62 disposed within the bore 32c is actuated such that the low pressure fluid is confined within the ninth flow aperture 42, including the enlarged region 42a thereof. Importantly, the volume disparity between the high and low pressure sections of the pressure transducer 76 requires that the same be “tuned”, with the disparate volumes between the high and low pressure sections of the pressure transducer 76 being compensated for by the path length of the section of the first flow channel 44 extending between the first flow aperture 24 and the ninth flow aperture 42, and the internal volume of the ninth flow aperture 42 including the enlarged region 42a thereof. These regions of the manifold block 12 create an internal compliance volume, with the size of the enlarged region 42a being a constant for the manifold block 12.

In another mode of operation of the manifold assembly 10, the same is “auto-zeroed” approximately once every minute during normal operation. To facilitate this auto-zero procedure, the solenoid 62 disposed within the bore 32c is actuated so as to close off the fluid communication between the fifth flow aperture 34 and sixth flow aperture 36, and to create a flow path between the ninth flow aperture 42 and the sixth flow aperture 36. Thus, the sixth flow aperture 36 is cut off from the high pressure fluid flowing to the fifth flow aperture 34 from the third flow channel 48. On the other hand, the low pressure fluid flowing to the ninth flow aperture 42 from the third flow aperture 28 via the first flow channel 44 is fluidly communicated to the sixth flow aperture 36, and hence to the second flow aperture 26 via the second flow channel 46. As a result, the low pressure fluid flows into both the low and high pressure ports 78, 80 of the pressure transducer 76. As a result, the pressure transducer 76 is “nulled” as needed to compensate for temperature and time drifts arising during the use of the manifold assembly 10.

Yet another mode of functionality of the manifold assembly 10 involves the placement of the seventh flow aperture 38 into fluid communication with the third flow aperture 28 concurrently with the placement of the eighth flow aperture 40 into fluid communication with the fourth flow aperture 30. During the other modes of operation of the manifold assembly 10 as described above, the solenoids 62 advanced into the bores 32a, 32b are actuated such that flow from the seventh flow aperture 38 to the third flow aperture 28 is cut-off, as is the flow from the eighth flow aperture 40 to the fourth flow aperture 30. As indicated above, the high pressure line 60 fluidly communicates with the seventh and eighth flow apertures 38, 40 via the fourth flow channel 50 extending therebetween and the high pressure coupling 58 which fluidly communicates with the fourth flow channel 50. The placement of the seventh flow aperture 38 into fluid communication with the third flow aperture 28 and concurrent placement of the eighth flow aperture 40 into fluid communication with the fourth flow aperture 30 facilitates the flow of high pressure fluid into the high and low pressure lines extending from the flow transducer to respective ones of the high and low pressure couplings 72, 74. This has the effect of “purging” these lines, which is used to keep the lines clear of condensation (moisture), and further is used to prevent contaminant migration into a device such as a ventilator which may also be interfaced to the manifold assembly 10. Like the auto-zero function described above, the purging function is also preferably completed approximately once every minute.

As is apparent from the foregoing description of the manifold assembly 10, the rubber or polymer construction of the manifold block 12 automatically forms a seal for all the ancillary components of the manifold assembly 10 directly engaged thereto. Within the manifold block 12, certain flow apertures and internal flow passages are formed through the use of large and small diameter pins which are caused to intersect in a manner eliminating “flashing”. Further, the ability to radially expand the bores 32a, 32b, 32c to accept the solenoids 62 overcomes a drawback associated with the use of prior art metal manifolds wherein the bores which accommodate the solenoids typically must be machined through the use of a specialized tool adapted to form internal grooves within the bores for accommodating the O-rings of the solenoids. As will be recognized, the necessity for this machining operation with a specialized tool substantially increases the cost associated with the fabrication of the manifold block.

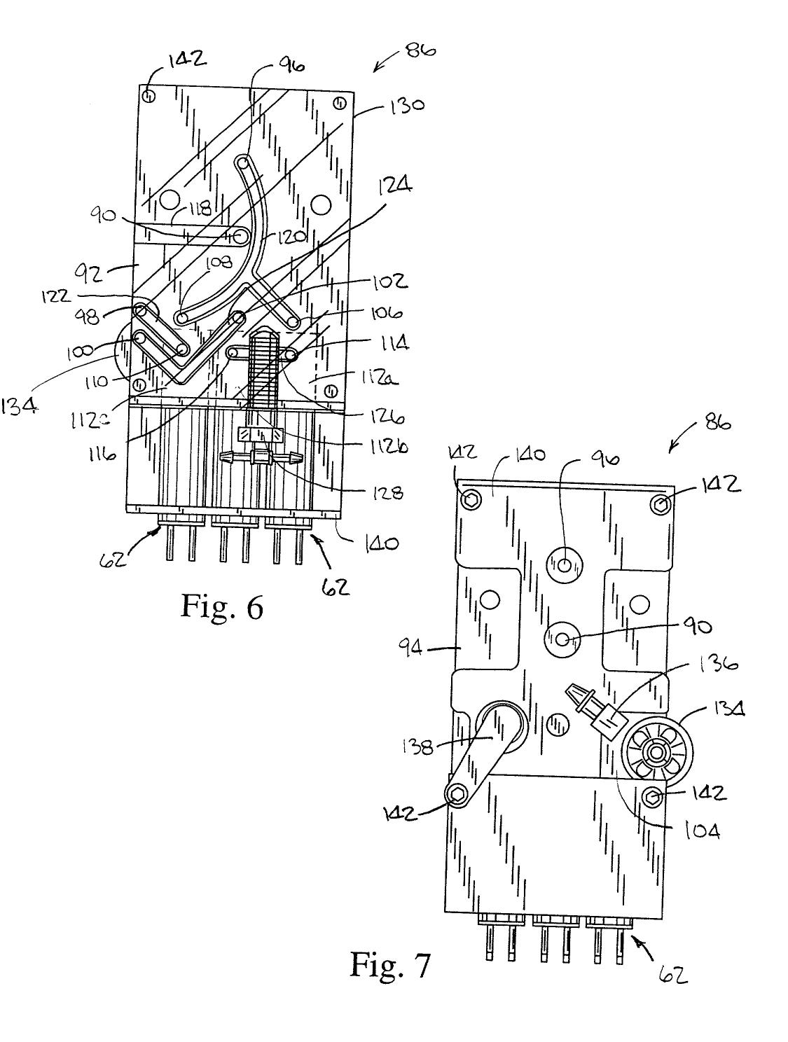

As also indicated above, the particular arrangement of the flow apertures, flow channels and internal flow passages within the manifold block 12 as described above is exemplary only, in that such arrangement is application-specific and may be varied according to application field. In this regard, referring now to FIGS. 6 and 7, there is depicted a manifold assembly 86 constructed in accordance with a second embodiment of the present invention. The manifold assembly 86 is specifically configured for use in conjunction with an esophageal balloon. The manifold assembly 86 includes a manifold block 88 which is identical to the above-described manifold block 12 except for a variation in the pattern of the flow apertures, flow channels, and internal flow passages therein. In this regard, the manifold block 88 includes a first flow aperture 90 which extends therethrough from the top surface 92 to the first bottom surface section 94 thereof. Also extending within the manifold block 88 is a second flow aperture 96 which is analogous to the above-described second flow aperture 26 and extends from the top surface 92 to the first bottom surface section 94. Those portions of the first and second flow apertures 90, 92 extending to the first bottom surface section 94 are of a diameter exceeding that of the remainders thereof.

Also formed within the manifold block 88 is a third flow aperture 98, a fourth flow aperture 100, and a fifth flow aperture 102. The third, fourth and fifth flow apertures 98, 100, 102 each extend from the top surface 92 of the manifold block 88 to the second bottom surface portion 104 thereof. A sixth flow aperture 106 also extends through the manifold block 88 between the top surface 92 and the second bottom surface portion 104. Seventh and eighth flow apertures 108, 110 extend to the top surface 92 of the manifold block 88, and are each placed into fluid communication with a bore 112c (analogous to the above-described bore 32c) via various internal flow passages of the manifold block 88. Finally, ninth and tenth flow apertures 114, 116 (which are analogous to the above-described seventh and eighth flow apertures 38, 40) extend from the top surface 92 into fluid communication with respective ones of bores 112a, 112b which, along with the bore 112c, are formed in a common lateral side surface section of the manifold block 88. The bores 112a, 112b, 112c are analogous to the bores 32a, 32b, 32c and accommodate respective ones of the above-described solenoids 62 which are included in the manifold assembly 86 of the second embodiment as well.

In the manifold block 88 of the manifold assembly 86, the first flow aperture 90 is placed into fluid communication with ambient air by a first flow channel 118 extending within the top surface 92 to one of the longitudinal side sections of the manifold block 88. The second flow aperture 96 is placed into fluid communication with each of the sixth and seventh flow apertures 106, 108 by a generally Y-shaped second flow channel 120 formed within the top surface 92. The third flow aperture 98 is placed into fluid communication with the eighth flow aperture 110 by a third flow channel 122 formed within the top surface 92, with the fourth flow aperture 100 being placed into fluid communication with the fifth flow aperture 102 by a generally L-shaped fourth flow channel 124 formed within the top surface 92. Finally, a fifth flow channel 126 also formed in the top surface 92 is used to place the ninth and tenth flow apertures 114, 116 into fluid communication with each other, the fifth flow channel 126 being analogous to the above-described fourth flow channel 50. A high pressure coupling 128 (analogous to the coupling 58) is threadably connected to the sealing plate 130 (which is identical to the sealing plate 54) of the manifold assembly 86 so as to be placed into fluid communication with the fifth flow channel 126 in the same manner described above with regard to the coupling 58 and fourth flow channel 50. Extending about the periphery of the second through fifth flow channels 120, 122, 124, 126 is a rib 132 which interacts with the sealing plate 130 to provide the same sealing function described above in relation to the ribs 52 and sealing plate 54.

The manifold assembly 86 of the second embodiment also includes the above-described pressure transducer 76 which is directly engaged to the manifold block 88 via the advancement of the low pressure port 78 into the first flow aperture 90, and the advancement of the high pressure port 80 into the second flow aperture 96. Thus, the low pressure port 98 communicates with ambient air via the first flow channel 118. The advancement of the ports 78, 80 into respective ones of the first and second flow apertures 90, 96 facilitates the creation of a seal between the pressure transducer 76 and the manifold block 88 in the manner previously described in relation to the pressure transducer 76 and manifold block 12. Seals are also created between the solenoids 62 and the manifold block 88 upon the advancement of the solenoids 62 into respective ones of the bores 112a, 112b, 112c in the same manner previously described in relation to the solenoids 62 and bores 32a, 32b, 32c.

As best seen in FIG. 7, the manifold assembly 86 of the second embodiment further comprises a vacuum pump 134 which is cooperatively engaged to the manifold block 88. The vacuum pump 134 includes a vacuum port which is advanced into the third flow aperture 98, and a pressure port which is advanced into the fourth flow aperture 100. The vacuum and pressure ports of the vacuum pump 134 are advanced into those portions of the third and fourth flow apertures 98, 100 extending to the second bottom surface portion 104 of the manifold block 88. The vacuum and pressure ports have diameters exceeding those of the third and fourth flow apertures 98, 100, thus facilitating the sealed engagement of the vacuum pump 134 to the manifold block 88 in the same manner described in relation to the sealed engagement between the pressure transducers 76 and manifold blocks 12, 88. Additionally, fluidly connected to the eighth flow aperture 110 of the manifold block 88 is a balloon coupling 136 which is placed into fluid communication with the esophageal balloon via a fluid line. A portion of the balloon coupling 136 is advanced into that portion of the eighth flow aperture 110 extending to the second bottom surface portion 104 of the manifold block 88. That portion of the balloon coupling 136 advanced into the eighth flow aperture 110 is of a diameter exceeding that of the eighth flow aperture 110 so as to facilitate the same sealing function previously described in relation to the engagement of the high and low pressure couplings 72, 74 to the manifold block 12.

Having thus described the various components of the manifold assembly 86, an exemplary mode of operation thereof in conjunction with the esophageal balloon will now be described. To facilitate the inflation of the balloon, the solenoid 62 disposed within the first bore 112a is actuated so as to facilitate the placement of the ninth flow aperture 114 into fluid communication with the sixth flow aperture 106. As a result, fluid flowing from a high pressure fluid line connected to the coupling 128 flows into the ninth flow aperture 114 via the fifth flow channel 126, and into the second flow channel 120 via the sixth flow aperture 106. This high pressure fluid introduced into the second flow channel 120 flows into the pressure transducer 76 via the second flow aperture 96 and high pressure port 80, and further flows into the seventh flow aperture 108 due to the configuration of the second flow channel 120. The solenoid 62 advanced into the bore 112c is itself actuated such that the seventh flow aperture 108 is placed into fluid communication with the eighth flow aperture 110. Thus, the high pressure fluid is able to flow from the seventh flow aperture 108 into the eighth flow aperture 110, and hence through the balloon coupling 136 into the balloon via the fluid line extending therebetween. At the same time, the solenoid 62 disposed within the bore 112b is actuated so as to close off any flow of high pressure fluid from the tenth flow aperture 116 to the fifth flow aperture 102.

When it is desired to deflate the balloon, the solenoid 62 disposed within the bore 112a is actuated so as to cut-off the fluid communication between the ninth flow aperture 114 and the sixth flow aperture 106. At the same time, the solenoid 62 within the bore 112b is opened to facilitate the placement of the tenth flow aperture 116 into fluid communication with the fifth flow aperture 102. High pressure fluid flowing from the tenth flow aperture 116 into the fifth flow aperture 102 in turn flows through the fourth flow channel 124 into the fourth flow aperture 100, and hence the pressure port of the vacuum pump 134. The application of high pressure fluid to the pressure port of the vacuum pump 134 activates the same in a manner facilitating the creation of a vacuum at the vacuum port and hence within the third flow aperture 98. The third flow aperture 98 fluidly communicates with the eighth flow aperture 110 via the third flow channel 122, with the solenoid 62 within the bore 112c being actuated so as to cut-off the fluid communication between the eighth flow aperture 110 and the seventh flow aperture 108. Thus, the vacuum is applied to the balloon coupling 136 via the eighth flow aperture 110 and hence the balloon to deflate the same. As seen in FIG. 7, cooperatively engaged to that end of the sixth flow aperture 106 extending to the second bottom surface portion 104 of the manifold block 88 is a relief valve 138. The relief valve 138 is operative to selectively vent the second flow channel 120.

As seen in FIGS. 6 and 7, the manifold assembly 86 of the second embodiment is further provided with a bracket 140 which is mounted to the first and second bottom surface sections 94, 104 of the manifold block 88, and secured thereto via the same fasteners 142 used to secure the sealing plate 130 to the manifold block 88. One such fastener 142 is also used to secure one end of the relief valve 138 to the second bottom surface portion 104 of the manifold block 88. The bracket 140 is used to provide support to the distal portions of the solenoids 62 in the manner best seen in FIG. 6. Those of ordinary skill in the art will recognize that the bracket 140 may be included in the manifold assembly 10 of the first embodiment for purposes of supporting the solenoids 62 thereof.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the spirit and scope of the invention.

1. A manifold assembly, comprising:
a manifold block defining:
a generally planar top surface;
a bottom surface;
a plurality of flow apertures extending between the top and bottom surfaces and from the top surface to an interior location of the manifold block; and
a plurality of flow channels disposed within the top surface in a pattern wherein each of at least some of the flow channels place at least two of the flow apertures into fluid communication with each other;
at least one solenoid cooperatively engaged to the manifold block in a manner facilitating the selective placement of at least two of the flow apertures into fluid communication with each other; and
a sealing plate attached to the manifold block in a manner covering each of the flow channels disposed within the top surface thereof.

2. The manifold assembly of claim 1 wherein the manifold block is fabricated from an elastomeric material.

3. The manifold assembly of claim 2 wherein the manifold block is fabricated from a material selected from the group consisting of:
a polymer material; and
a rubber material.

4. The manifold assembly of claim 2 wherein:
each of the flow channels defines a peripheral edge; and
the manifold block includes a plurality of ribs formed on and extending upwardly from the top surface thereof;
each of the ribs extending along the peripheral edge of a respective one of the flow channels.

5. The manifold assembly of claim 2 wherein:
the manifold block defines at least one side surface extending between the top and bottom surfaces;
at least one bore is formed within the side surface of the manifold block; and
the solenoid is partially advanced into the bore.

6. The manifold assembly of claim 5 wherein:
the bore is formed to have a bore diameter; and
a portion of the solenoid which is advanced into the bore has a body diameter which slightly exceeds the bore diameter such that the solenoid is maintained in sealed engagement to the manifold block.

7. The manifold assembly of claim 2 further comprising a pressure transducer cooperatively engaged to the manifold block in a manner communicating with at least two of the flow apertures formed therein.

8. The manifold assembly of claim 7 wherein:
the pressure transducer includes a pair of ports which each have a port diameter and are advanceable into a respective pair of the flow apertures; and
the flow apertures which receive the ports of the pressure transducer each have an aperture diameter which is slightly less than the port diameter of each of the ports such that the pressure transducer is maintained in sealed engagement to the manifold block.

9. The manifold assembly of claim 1 wherein at least one of the flow channels extends within the top surface of the manifold block in a manner facilitating the placement of at least one of the flow apertures into fluid communication with ambient air.
